(19) United States
(12) Patent Application Publication
(10) Pub. No.: US 2023/0191405 A1
(43) Pub. Date: Jun. 22, 2023

(54) INSTRUMENTS, SYSTEMS, AND METHODS FOR MEASURING LIQUID FLOW THROUGH CHANNELS

(71) Applicant: ILLUMINA, INC., San Diego, CA (US)

(72) Inventors: Zhenning Cao, San Diego, CA (US); Jennifer Foley, San Diego, CA (US); Cyril Delattre, Lyon (FR); Maulik Patel, San Diego, CA (US); Cameron Mar, San Diego, CA (US)

(73) Assignee: ILLUMINA, INC., San Diego, CA (US)

(21) Appl. No.: 18/069,688

(22) Filed: Dec. 21, 2022

Related U.S. Application Data
(60) Provisional application No. 63/292,658, filed on Dec. 22, 2021.

(51) Int. Cl. B01L 3/00; G01F 3/38

(52) U.S. Cl. CPC B01L 3/50273; G01F 3/38; B01L 2200/04; B01L 2200/16; B01L 2300/0627; B01L 2400/0487

(57) ABSTRACT

In some examples, an instrument for measuring a volume of a liquid is provided. A gas flow rate sensor may measure a rate of flow of a pressurized gas to a reservoir storing a liquid. A controller may be coupled to the gas flow rate sensor and may calculate a volume of the liquid that the flow of pressurized gas displaces from the reservoir. In some examples, a method of measuring a volume of a liquid is provided. Using a gas flow rate sensor, a flow of pressurized gas may be measured. The flow of the pressurized gas may be delivered to a reservoir storing a liquid. A volume of the liquid in the reservoir may be displaced using the flow of pressurized gas. The measurement of the flow of the pressurized gas may be used to calculate the volume of the liquid that is displaced.

### CROSS-REFERENCE TO RELATED APPLICATIONS

This application claims the benefit of U.S. Provisional Pat. Application No. 63/292,658, filed Dec. 22, 2021, entitled “Instruments, Systems, and Methods for Measuring Liquid Flow Through Channels,” the entire contents of which are incorporated by reference herein.

### BACKGROUND

Channels are used in many technological applications. For example, certain molecular analyses, such as certain polynucleotide sequencing methods like sequencing-by-synthesis (SBS), utilize polynucleotides that are coupled within a channel (sometimes referred to as a flow cell). For example, oligonucleotide primers (e.g., single stranded DNA or ssDNA) may be grafted to the flow cell and used to amplify target polynucleotides for sequencing. Syringe pumps have been used to pull different liquids through the flow cell at different times, for example so as to introduce different reagents to the flow cell for use in amplifying or sequencing target polynucleotides therein. The syringe pump and the flow cell may be located in a cartridge that is removably coupled to the sequencing instrument and may be recycled or discarded after use.

### SUMMARY

Examples provided herein are related to instruments, systems, and methods for measuring liquid flow through channels.

Some examples herein provide an instrument. The instrument may include a gas flow rate sensor to measure a rate of flow of a pressurized gas to a reservoir storing a liquid. The instrument may include a controller coupled to the gas flow rate sensor to calculate a volume of the liquid that the flow of pressurized gas displaces from the reservoir.

In some examples, the flow of pressurized gas displaces a plurality of fluids from a plurality of reservoirs storing respective liquids. The controller calculates volumes of the respective liquids that the flow of pressurized gas displaces from the respective reservoirs. In some examples, the respective liquids include reagents. In some examples, the reservoirs are located within a cartridge that is removably coupled to the instrument. In some examples, the controller may actuate a plurality of actuators to selectively control the displacement of the liquids. In some examples, the actuators include valves. In some examples, the actuators are located on the cartridge.

In some examples, the liquid is displaced into a channel. In some examples, the channel includes a flow cell.

In some examples, the gas includes nitrogen.

In some examples, the instrument further includes a pressure regulator coupled upstream of the gas flow rate sensor.

Some examples herein provide a system. The system may include the instrument and cartridge provided herein.

Some examples herein provide a cartridge. The cartridge may include a gas manifold to receive a flow of a pressurized gas. The cartridge may include a plurality of reservoirs storing respective liquids. The cartridge may include a channel to receive liquids dispensed from the plurality of reservoirs responsive to flow of the pressurized gas from the gas manifold into respective reservoirs. The cartridge may include a plurality of actuators, each coupled to the channel and to a respective reservoir. The cartridge may include an electrical connector to electrically couple the actuators to a controller.

In some examples, the cartridge further includes a waste reservoir to receive liquids from the channel.

In some examples, the cartridge further includes the respective liquids. In some examples, the respective liquids include reagents.

In some examples, the cartridge is removably couplable to an instrument. In some examples, the actuators include valves. In some examples, the channel includes a flow cell. In some examples, the cartridge lacks a sensor for measuring flow of the respective liquids. In some examples, the cartridge lacks a syringe pump for pulling the respective liquids.

Some examples herein provide a system. The system may include the cartridge and the instrument provided herein.

Some examples herein provide a method. The method may include measuring a rate of flow of a pressurized gas. The method may include delivering the flow of the pressurized gas to at least one reservoir storing at least one liquid so as to displace a volume of the at least one liquid in the at least one reservoir using the flow of pressurized gas. The method may include using the measurement of the rate of flow of the pressurized gas to calculate the volume of the liquid that is displaced.

In some examples, the at least one reservoir includes at least two reservoirs. In some examples, the method further includes using the flow of the pressurized gas to sequentially dispense at least one liquid from each of the at least two reservoirs for a fixed time period. In some examples, the fixed time period for each reservoir can be variable relative to other reservoirs. In some examples, the at least one liquid includes at least two liquids, and each of the reservoirs includes a different liquid.

In some examples, the flow of pressurized gas displaces a plurality of fluids from a plurality of reservoirs storing respective liquids. The method may include calculating volumes of the respective liquids that the flow of pressurized gas displaces from the respective reservoirs. In some examples, the respective liquids include reagents. In some examples, the plurality of reservoirs is located within a cartridge. Some examples include removably coupling the cartridge to an instrument. Some examples include actuating a plurality of actuators to selectively control the displacement of the liquids. In some examples, the actuators include valves. In some examples, the actuators are located on a cartridge.

In some examples, the liquid is displaced into a channel. In some examples, the channel includes a flow cell.

In some examples, the gas includes nitrogen. Some examples include regulating the pressure of the gas upstream of the gas flow rate sensor.

Some examples include fluidically coupling a gas manifold to the flow of the pressurized gas; electrically coupling an actuator to a controller; actuating the actuator to fluidically couple the reservoir to a channel; and receiving, by the channel, the liquid dispensed from the reservoir. Some examples include receiving, by a waste reservoir, the liquid from the channel.

In some examples, the gas manifold and the actuator are located in a cartridge, and the controller is located in an instrument. Some examples include removably coupling the cartridge to an instrument.

In some examples, the actuator includes a valve. In some examples, the channel includes a flow cell.

Some examples herein provide a method. The method may include measuring a rate of flow of a pressurized gas using an air mass flow sensor of an instrument. The method may include delivering the flow of the pressurized gas to a reservoir on a cartridge whereby the flow of pressurized gas displaces a volume of liquid stored in the reservoir. The cartridge may be removably coupled to the instrument. The method may include calculating the volume of liquid that is displaced from the reservoir using the measurement of the rate of flow of the pressurized gas.

Some examples herein provide a system. The system may include any of the cartridges provided herein, and may include any of the instruments provided herein.

It is to be understood that any respective features/examples of each of the aspects of the disclosure as described herein may be implemented together in any appropriate combination, and that any features/examples from any one or more of these aspects may be implemented together with any of the features of the other aspect(s) as described herein in any appropriate combination to achieve the benefits as described herein.

### BRIEF DESCRIPTION OF DRAWINGS

FIG. 1 schematically illustrates an example system for measuring liquid flow through a channel.

FIG. 2 schematically illustrates properties of selected components of the example system of FIG. 1.

FIG. 3 illustrates an example flow of operations in a method for measuring liquid flow through a channel.

FIG. 4 illustrates an example flow of operations in a method for calibrating a measurement of liquid flow through a channel.

FIGS. 5A-5B are plots respectively illustrating the simulated air volumetric flow rate and corresponding reagent flow rate for different starting parameters.

FIG. 6 is a plot illustrating a comparison of the simulated air volumetric flow rate and corresponding reagent flow rate for different starting parameters.

FIG. 7 is a plot illustrating the mismatch between the simulated air volumetric flow rate and corresponding reagent flow rate for different starting parameters.

FIG. 8 schematically illustrates a setup used to calculate volumes of liquid displaced by a pressurized gas.

FIG. 9A illustrates the volumes of liquid and pressurized gas measured using the setup of FIG. 8.

FIG. 9B illustrates the percentage error of the volumes of liquid calculated using the setup of FIG. 8.

### DETAILED DESCRIPTION

Examples provided herein are related to instruments, systems, and methods for measuring liquid flow through channels.

For example, in previously known systems for sequencing polynucleotides, liquids are driven by syringe pumps using negative pressure in which the liquid is pulled rather than pushed into a flow cell. The amount of liquid delivered to the flow cell is correlated to the volumetric displacement of the syringe barrel. However, using negative pressure to pull liquids through flow cells may limit performance of the system. For example, the flow rate may be limited by the maximum negative pressure generated by the syringe pump. Additionally, sufficiently high negative pressures may cause outgassing and/or cavitation in the liquid which may detrimentally affect any imaging being performed on the flow cell. Additionally, it may take a relatively long time for the syringe pump to achieve a steady state flow rate and thus to deliver a liquid to the flow cell. Additionally, integrating the syringe pump into the same removable cartridge as the flow cell may increase the cost and complexity of manufacturing the cartridge.

In polynucleotide sequencing, it is useful to accurately and precisely measure the amounts of different liquids that are delivered to the flow cell. For example, the liquids may include reagents for use in amplifying or sequencing target polynucleotides therein, and the respective volumes of those liquids correlate to the amounts of reagents being used. As provided herein, a pressurized gas may be used to control liquid flow through a channel. More specifically, the gas is used to displace liquid from a reservoir, and the displaced liquid is delivered to a channel, such as a flow cell. In a manner such as will be explained in herein, the flow of the pressurized gas may be measured, and such measurement may be used to calculate the volume of the liquid that is displaced by the gas. Use of a pressurized gas to control liquid flow through a channel may solve problems such as described above for negative pressure systems. For example, the pressurized gas may be set to any suitable pressure and is not limited by a maximum negative pressure that may be generated by a syringe pump. As another example, the positive pressure of the gas may inhibit outgassing and/or cavitation in the liquid, and thus is more compatible with imaging or other measurement of the flow cell than a liquid being flowed under negative pressure. As another example, the flow of the pressurized gas may be started and stopped relatively quickly using actuators, thus reducing the amount of time to achieve a steady state flow rate and thus to deliver a liquid to the flow cell.

First, some terms used herein will be briefly explained. Then, some example systems and methods for measuring liquid flow through channels will be described.

### Terms

Unless defined otherwise, all technical and scientific terms used herein have the same meaning as is commonly understood by one of ordinary skill in the art. The use of the term “including” as well as other forms, such as “include,” “includes,” and “included,” is not limiting. The use of the term “having” as well as other forms, such as “have,” “has,” and “had,” is not limiting. As used in this specification, whether in a transitional phrase or in the body of the claim, the terms “comprise(s)” and “comprising” are to be interpreted as having an open-ended meaning. That is, the above terms are to be interpreted synonymously with the phrases “having at least” or “including at least.” For example, when used in the context of a process, the term “comprising” means that the process includes at least the recited steps, but may include additional steps. When used in the context of a compound, composition, or device, the term “comprising” means that the compound, composition, or device includes at least the recited features or components, but may also include additional features or components.

The terms “substantially”, “approximately”, and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

As used herein, the term “nucleotide” is intended to mean a molecule that includes a sugar and at least one phosphate group, and in some examples also includes a nucleobase. Nucleotides include deoxyribonucleotides, modified deoxyribonucleotides, ribonucleotides, modified ribonucleotides, peptide nucleotides, modified peptide nucleotides, modified phosphate sugar backbone nucleotides, and mixtures thereof. Examples of nucleotides include adenosine monophosphate (AMP), adenosine diphosphate (ADP), adenosine triphosphate (ATP), thymidine monophosphate (TMP), thymidine diphosphate (TDP), thymidine triphosphate (TTP), cytidine monophosphate (CMP), cytidine diphosphate (CDP), cytidine triphosphate (CTP), guanosine monophosphate (GMP), guanosine diphosphate (GDP), guanosine triphosphate (GTP), uridine monophosphate (UMP), uridine diphosphate (UDP), uridine triphosphate (UTP), deoxyadenosine monophosphate (dAMP), deoxyadenosine diphosphate (dADP), deoxyadenosine triphosphate (dATP), deoxythymidine monophosphate (dTMP), deoxythymidine diphosphate (dTDP), deoxythymidine triphosphate (dTTP), deoxycytidine diphosphate (dCDP), deoxycytidine triphosphate (dCTP), deoxyguanosine monophosphate (dGMP), deoxyguanosine diphosphate (dGDP), deoxyguanosine triphosphate (dGTP), deoxyuridine monophosphate (dUMP), deoxyuridine diphosphate (dUDP), and deoxyuridine triphosphate (dUTP).

As used herein, the term “nucleotide” also is intended to encompass any nucleotide analogue which is a type of nucleotide that includes a modified nucleobase, sugar and/or phosphate moiety compared to naturally occurring nucleotides. Example modified nucleobases include inosine, xathanine, hypoxathanine, isocytosine, isoguanine, 2-aminopurine, 5-methylcytosine, 5-hydroxymethyl cytosine, 2-aminoadenine, 6-methyl adenine, 6-methyl guanine, 2-propyl guanine, 2-propyl adenine, 2-thiouracil, 2-thiothymine, 2-thiocytosine, 15-halouracil, 15-halocytosine, 5-propynyl uracil, 5-propynyl cytosine, 6-azo uracil, 6-azo cytosine, 6-azo thymine, 5-uracil, 4-thiouracil, 8-halo adenine or guanine, 8-amino adenine or guanine, 8-thiol adenine or guanine, 8-thioalkyl adenine or guanine, 8-hydroxyl adenine or guanine, 5-halo substituted uracil or cytosine, 7-methylguanine, 7-methyladenine, 8-azaguanine, 8-azaadenine, 7-deazaguanine, 7-deazaadenine, 3-deazaguanine, 3-deazaadenine or the like. As is known in the art, certain nucleotide analogues cannot become incorporated into a polynucleotide, for example, nucleotide analogues such as adenosine 5′-phosphosulfate. Nucleotides may include any suitable number of phosphates, e.g., three, four, five, six, or more than six phosphates.

As used herein, the term “polynucleotide” refers to a molecule that includes a sequence of nucleotides that are bonded to one another. A polynucleotide is one nonlimiting example of a polymer. Examples of polynucleotides include deoxyribonucleic acid (DNA), ribonucleic acid (RNA), locked nucleic acid (LNA), peptide nucleic acid (PNA), and analogues thereof. A polynucleotide may be a single stranded sequence of nucleotides, such as RNA or single stranded DNA, a double stranded sequence of nucleotides, such as double stranded DNA, DNA that is folded to form a hairpin that is partially single stranded and partially double stranded, double-stranded amalgamations in which there are molecules that are non-covalently coupled to one another (e.g., via reversible hydrogen binding), and/or may include a mixture of a single stranded and double stranded sequences of nucleotides. Double stranded DNA (dsDNA) includes genomic DNA, and PCR and amplification products. Single stranded DNA (ssDNA) can be converted to dsDNA and vice-versa. Polynucleotides may include non-naturally occurring DNA, such as enantiomeric DNA. The precise sequence of nucleotides in a polynucleotide may be known or unknown. The following are examples of polynucleotides: a gene or gene fragment (for example, a probe, primer, expressed sequence tag (EST) or serial analysis of gene expression (SAGE) tag), genomic DNA, genomic DNA fragment, exon, intron, messenger RNA (mRNA), transfer RNA, ribosomal RNA, ribozyme, cDNA, recombinant polynucleotide, synthetic polynucleotide, branched polynucleotide, plasmid, vector, isolated DNA of any sequence, isolated RNA of any sequence, nucleic acid probe, primer or amplified copy of any of the foregoing.

As used herein, the term “target polynucleotide” is intended to mean a polynucleotide that is the object of an analysis or action. The analysis or action includes subjecting the polynucleotide to amplification, sequencing, and/or other procedure. A target polynucleotide may include nucleotide sequences additional to a target sequence to be analyzed. For example, a target polynucleotide may include one or more adapters, including an adapter that functions as a primer binding site, that flank(s) a target polynucleotide sequence that is to be analyzed. A target polynucleotide hybridized to a capture primer may include nucleotides that extend beyond the 5′ or 3′ end of the capture oligonucleotide in such a way that not all of the target polynucleotide is amenable to extension. In particular examples, target polynucleotides may have different sequences than one another but may have first and second adapters that are the same as one another. The two adapters that may flank a particular target polynucleotide sequence may have the same sequence as one another, or complementary sequences to one another, or the two adapters may have different sequences. Thus, species in a plurality of target polynucleotides may include regions of known sequence that flank regions of unknown sequence that are to be evaluated by, for example, sequencing (e.g., SBS). In some examples, target polynucleotides carry an adapter at a single end, and such adapter may be located at either the 3′ end or the 5′ end the target polynucleotide. Target polynucleotides may be used without any adapter, in which case a primer binding sequence may come directly from a sequence found in the target polynucleotide.

The terms “polynucleotide” and “oligonucleotide” are used interchangeably herein. The different terms are not intended to denote any particular difference in size, sequence, or other property unless specifically indicated otherwise. For clarity of description the terms may be used to distinguish one species of polynucleotide from another when describing a particular method or composition that includes several polynucleotide species.

As used herein, a “polymerase” is intended to mean an enzyme having an active site that assembles polynucleotides by polymerizing nucleotides into polynucleotides. A polymerase can bind a primed single stranded target polynucleotide, and can sequentially add nucleotides to the growing primer to form a “complementary copy” polynucleotide having a sequence that is complementary to that of the target polynucleotide. Another polymerase, or the same polymerase, then can form a copy of the target nucleotide by forming a complementary copy of that complementary copy polynucleotide. DNA polymerases may bind to the target polynucleotide and then move down the target polynucleotide sequentially adding nucleotides to the free hydroxyl group at the 3′ end of a growing polynucleotide strand (growing amplicon). DNA polymerases may synthesize complementary DNA molecules from DNA templates and RNA polymerases may synthesize RNA molecules from DNA templates (transcription). Polymerases may use a short RNA or DNA strand (primer), to begin strand growth. Some polymerases may displace the strand upstream of the site where they are adding bases to a chain. Such polymerases may be said to be strand displacing, meaning they have an activity that removes a complementary strand from a template strand being read by the polymerase. Example polymerases having strand displacing activity include, without limitation, the large fragment of Bst (Bacillus stearothermophilus) polymerase, exo-Klenow polymerase or sequencing grade T7 exo-polymerase. Some polymerases degrade the strand in front of them, effectively replacing it with the growing chain behind (5′ exonuclease activity). Some polymerases have an activity that degrades the strand behind them (3′ exonuclease activity). Some useful polymerases have been modified, either by mutation or otherwise, to reduce or eliminate 3′ and/or 5′ exonuclease activity.

As used herein, the term “primer” refers to a polynucleotide to which nucleotides may be added via a free 3′ OH group. The primer length may be any suitable number of bases long and may include any suitable combination of natural and non-natural nucleotides. A target polynucleotide may include an “adapter” that hybridizes to (has a sequence that is complementary to) a primer, and may be amplified so as to generate a complementary copy polynucleotide by adding nucleotides to the free 3′ OH group of the primer. A “capture primer” refers to a primer that is coupled to a substrate. In some examples, capture primers are P5 and P7 primers that are commercially available from Illumina, Inc. (San Diego, CA). In some examples, primers (such as primers or P5 or P7 primers) include a linker or spacer at the 5′ end. Such linker or spacer may be included in order to permit chemical or enzymatic cleavage, or to confer some other desirable property, for example to enable covalent attachment to a substrate, or to act as spacers to position a site of cleavage an optimal distance from the solid support. In certain cases, 10 spacer nucleotides may be positioned between the point of attachment of the P5 or P7 primers to a polymer or a solid support. In some examples, polyT spacers are used, although other nucleotides and combinations thereof can also be used. In one example, the spacer is a 6T to 10T spacer. In some examples, the linkers include cleavable nucleotides including a chemically cleavable functional group such as a vicinal diol or allyl T.

As used herein, the term “amplicon,” when used in reference to a polynucleotide, is intended to mean a product of copying the polynucleotide, wherein the product has a nucleotide sequence that is substantially the same as, or is substantially complementary to, at least a portion of the nucleotide sequence of the polynucleotide. “Amplification” and “amplifying” refer to the process of making an amplicon of a polynucleotide. A first amplicon of a target polynucleotide may be a complementary copy. Additional amplicons are copies that are created, after generation of the first amplicon, from the target polynucleotide or from the first amplicon. A subsequent amplicon may have a sequence that is substantially complementary to the target polynucleotide or is substantially identical to the target polynucleotide. It will be understood that a small number of mutations (e.g., due to amplification artifacts) of a polynucleotide may occur when generating an amplicon of that polynucleotide.

As used herein, the term “substrate” refers to a material that includes a solid support. A substrate may include a polymer that defines the solid support, or that is disposed on the solid support. Example substrate materials may include glass, silica, plastic, quartz, metal, metal oxide, organo-silicate (e.g., polyhedral organic silsesquioxanes (POSS)), polyacrylates, tantalum oxide, complementary metal oxide semiconductor (CMOS), or combinations thereof. An example of POSS can be that described in Kehagias et al., Microelectronic Engineering 86 (2009), pp. 776-778, which is incorporated by reference in its entirety. Illustratively, POSS-containing monomers may be polymerised reaching a gel-point rapidly to furnish a POSS resin (a polymer functionalized to include POSS) on which soft material functionalisation may be performed. In some examples, substrates used in the present application include silica-based substrates, such as glass, fused silica, or other silica-containing material. In some examples, substrates may include silicon, silicon nitride, or silicone hydride. In some examples, substrates used in the present application include plastic materials or components such as polyethylene, polystyrene, poly(vinyl chloride), polypropylene, nylons, polyesters, polycarbonates, and poly(methyl methacrylate). Example plastics materials include poly(methyl methacrylate), polystyrene, cyclic olefin copolymer, and cyclic olefin polymer substrates. In some examples, the substrate is or includes a silica-based material or plastic material or a combination thereof. In particular examples, the substrate has at least one surface comprising glass or a silicon-based polymer. In some examples, the substrates may include a metal. In some such examples, the metal is gold. In some examples, the substrate has at least one surface comprising a metal oxide. In one example, the surface comprises a tantalum oxide or tin oxide. Acrylamides, enones, or acrylates may also be utilized as a substrate material or component. Other substrate materials may include, but are not limited to gallium arsenide, indium phosphide, aluminum, ceramics, polyimide, quartz, resins, polymers and copolymers. In some examples, the substrate and/or the substrate surface may be, or include, quartz. In some other examples, the substrate and/or the substrate surface may be, or include, semiconductor, such as GaAs or ITO. The foregoing lists are intended to be illustrative of, but not limiting to the present application. Substrates may comprise a single material or a plurality of different materials. Substrates may be composites or laminates. In some examples, the substrate comprises an organo-silicate material. Substrates may be flat, round, spherical, rod-shaped, or any other suitable shape. Substrates may be rigid or flexible. In some examples, a substrate is a bead or a flow cell.

In some examples, a substrate includes a patterned surface. A “patterned surface” refers to an arrangement of different regions in or on an exposed layer of a substrate. For example, one or more of the regions may be features where one or more capture primers are present. The features can be separated by interstitial regions where capture primers are not present. In some examples, the pattern may be an x-y format of features that are in rows and columns. In some examples, the pattern may be a repeating arrangement of features and/or interstitial regions. In some examples, the pattern may be a random arrangement of features and/or interstitial regions. In some examples, the substrate includes an array of wells (depressions) in a surface. The wells may be provided by substantially vertical sidewalls. In some examples, the substrate includes an array of posts (protrusions) in a surface. Wells and posts may be fabricated as is generally known in the art using a variety of techniques, including, but not limited to, photolithography, stamping techniques, molding techniques, nano-imprint lithography, and microetching techniques. As will be appreciated by those in the art, the technique used will depend on the composition and shape of the array substrate. Illustratively, posts having diameters between about 50 nm to about 500 nm may be referred to as nanoposts, and may have heights of similar dimension to the diameters.

The features in a patterned surface of a substrate may include an array of features (e.g., wells such as microwells or nanowells, or posts such as nanoposts) on glass, silicon, plastic or other suitable material(s) with patterned, covalently-linked gel such as poly(N-(5-azidoacetamidylpentyl) acrylamide-co-acrylamide) (PAZAM). The process creates gel pads used for sequencing that may be stable over sequencing runs with a large number of cycles. The covalent linking of the polymer to the wells may be helpful for maintaining the gel in the structured features throughout the lifetime of the structured substrate during a variety of uses. However in many examples, the gel need not be covalently linked to the wells. For example, in some conditions silane free acrylamide (SFA) which is not predominantly covalently attached to any part of the structured substrate, may be used as the gel material.

In particular examples, a structured substrate may be made by patterning a suitable material with wells (e.g. microwells or nanowells), coating the patterned material with a gel material (e.g., PAZAM, SFA or chemically modified variants thereof, such as the azidolyzed version of SFA (azido-SFA)) and polishing the surface of the gel coated material, for example via chemical or mechanical polishing, thereby retaining gel in the wells but removing or inactivating substantially all of the gel from the interstitial regions on the surface of the structured substrate between the wells. Primers may be attached to gel material. A solution including a plurality of target polynucleotides (e.g., a fragmented human genome or portion thereof) may then be contacted with the polished substrate such that individual target polynucleotides will seed individual wells via interactions with primers attached to the gel material; however, the target polynucleotides will not occupy the interstitial regions due to absence or inactivity of the gel material. Amplification of the target polynucleotides may be confined to the wells because absence or inactivity of gel in the interstitial regions may inhibit outward migration of the growing cluster. The process is conveniently manufacturable, being scalable and utilizing conventional micro- or nano-fabrication methods.

A patterned substrate may include, for example, wells etched provided in a slide or chip. The pattern of the etchings and geometry of the wells may take on a variety of different shapes and sizes, and such features may be physically or functionally separable from each other. Particularly useful substrates having such structural features include patterned substrates that may select the size of solid particles such as microspheres. An example patterned substrate having these characteristics is the etched substrate used in connection with BEAD ARRAY technology (Illumina, Inc., San Diego, Calif.). Nano-imprint lithography (NIL) may be used to provide wells.

In some examples, a substrate described herein forms at least part of a flow cell or is located in or coupled to a flow cell. Flow cells may include a flow chamber that includes at least one lane and may be divided into a plurality of lanes or a plurality of sectors. Example flow cells and substrates for manufacture of flow cells that may be used in methods and compositions set forth herein include, but are not limited to, those commercially available from Illumina, Inc. (San Diego, CA).

As used herein, the term “channel” refers to an elongated, at least partially enclosed structure through which a liquid may flow, e.g., through which a liquid may be directed. A channel may have a length, a width, and a height. The width and height, together, may define a cross-sectional area of the channel. The cross-section of the channel may have any suitable shape, e.g., may be completely curved, partially curved, a completely polygonal, or partially polygonal. Illustratively, the cross-section of the channel may be circular, oval, square, rectangular, or the like. The fluid may substantially fill the cross-sectional area of the fluidic channel. The fluid may flow along the length of the channel. A channel may be formed by a cover coupled to a substrate. A flow cell is a nonlimiting example of a channel.

As used herein, the term “cover” refers to a substrate that may be coupled to another substrate to form a channel. As such, a cover may include any of the materials described elsewhere herein that may be included in a substrate. A cover may include the same material(s) as the substrate to which it is coupled, or may include one or more different materials than the substrate to which it is coupled. A cover may be coupled directly to a substrate, or may be coupled to an intervening layer that is coupled to a substrate. Although a region of a cover may be described and illustrated as being “over” a substrate, this is intended only to mean that the cover and the substrate are spaced apart from one another, rather than to imply any particular spatial orientation of the cover relative to the substrate. A cover may include a recess configured such that, when the cover is coupled to the substrate, the recess is spaced apart from the substrate so as to provide a channel. Conversely, the substrate may include a recess configured such that, when the cover is coupled to the substrate, the recess is spaced apart from the cover so as to provide a channel.

### Instruments, Systems, and Methods for Measuring Liquid Flow Through a Channel

As noted above and as described in greater detail below, the present instruments, systems, and methods may be used to measure the flow of liquid that is dispensed into a channel. In particular, the present instruments, systems, and methods provide for the measurement and control of the respective volumes of liquids that respectively may be dispensed into a channel. The measurement may be performed using a gas flow rate sensor to measure the volumetric flow rate of a pressurized gas that is used to drive different liquids out of reservoirs and into a channel. From the measurement of the gas flow rate, the volume of gas that is used to dispense the liquid may be calculated and may be correlated to the volume of liquid that is dispensed. The measurement thus may be performed by a “dry instrument” in which the liquid does not contact the gas flow rate sensor. In comparison, a “wet instrument” would directly measure the flow rate of the liquid itself. However, liquid flow meters are relatively expensive and therefore likely would benefit from being reusable in order to be cost effective. However, reusing a liquid flow meter may result in the liquid flow meter being contaminated and potentially degraded by the liquid or reagent(s) therein, and may result in the liquid itself becoming contaminated.

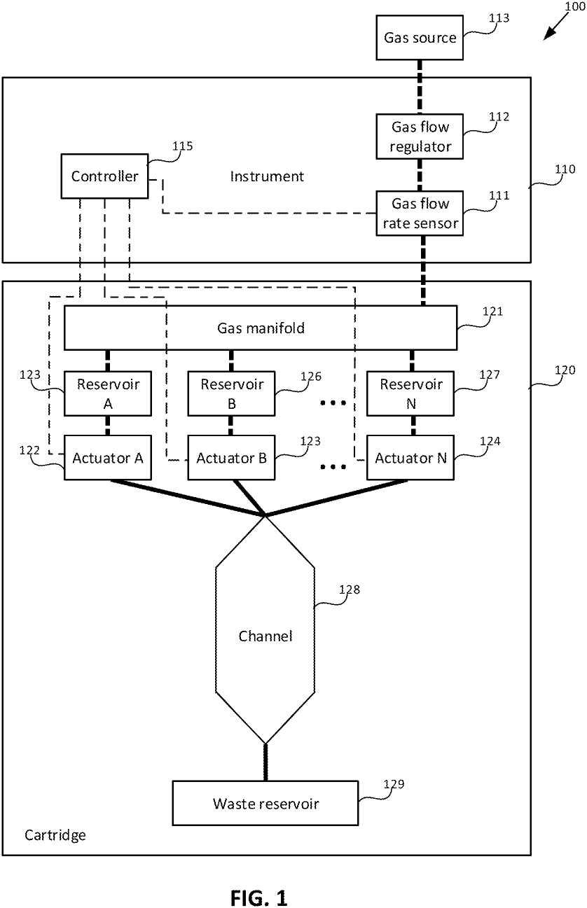

FIG. 1 schematically illustrates an example system 100 for measuring liquid flow through a channel. In FIG. 1, gas channels connecting components to one another are illustrated in bold dashed lines, liquid channels connecting components to one another are illustrated in bold solid lines, and electrical connections connecting components to one another are illustrated in narrow dash-dot lines. System 100 may include instrument 110 and cartridge 120 that is removably coupled to instrument 110. For example, cartridge 120 may be coupled to instrument 110 via electrical connections and via a gas channel in a manner such as illustrated in FIG. 1. In one nonlimiting example, instrument 110 may include a polynucleotide sequencing instrument, e.g., an SBS instrument such as commercially available from Illumina, Inc. (San Diego, CA). However, it will be appreciated that the present subject matter readily may be adapted to measure and control the flow of liquid in any suitable context or application.

Instrument 110 may be configured to measure a volume of a liquid. For example, instrument 110 may include gas flow rate sensor 111 configured to measure a rate of flow of a pressurized gas to a reservoir storing a liquid. Illustratively, instrument 110 may include or may be coupled to gas source 113 storing a suitably inert gas, such as nitrogen, air, or a noble gas. Instrument 110 may include gas flow regulator 112 coupling gas source 113 to gas flow rate sensor 111. Gas flow rate sensor 111 may measure the time-dependent rate of flow of the pressurized gas in any suitable manner, e.g., may measure the gas volumetric flow rate Q_{gas}(t), the gas mass flow rate ṁ_{gas}(t), and/or the integrated gas volume V(t₂-t₁) between a first time t₁ and a second time t₂. The volumetric flow rate can be accurately calibrated for a given gas used (e.g., nitrogen, air, or noble gas) at any given surrounding pressure by an internal pressure sensor embedded in the gas flow meter 111 or external pressure sensor if the gas flow sensor/meter does not have any pressure sensor to calibrate. Instrument 110 also may include controller 115 coupled to gas flow rate sensor 111 and configured to calculate a volume of the liquid that the flow of pressurized gas displaces from the reservoir in a manner such as described in greater detail below. For example, gas flow rate sensor 111 may be configured to output to controller 115 any suitable combination of Q_{gas}(t), ṁ_{gas} (t), V(t₂-t₁), and/or P(t). Gas flow rate sensors are commercially available, e.g., from Alicat Scientific (Tucson, AZ). For example, Alicat M-series gas mass flow meters (such as M-10SCCM-D/5M) may output Q_{gas}(t) or ṁ_{gas} (t)and P(t), and may include the totalizer function which calculates and outputs V(t₂-t₁).

The reservoir from which the pressurized gas displaces the liquid may be located within cartridge 120. Cartridge 120 may lack a syringe pump for pulling respective liquid(s). Instead, in the example illustrated in FIG. 1, cartridge 120 may include gas manifold 121 configured to receive a flow of a pressurized gas, e.g., the gas from gas flow rate sensor 111 via a gas channel such as any suitable combination of tubes, pipes, lumens, gas connectors, and the like. Cartridge 120 may include a reservoir configured to store the liquid and coupled to the gas flow rate sensor 111, e.g., via gas manifold 121 and gas channel(s). In the nonlimiting example illustrated in FIG. 1, cartridge 120 may include a plurality of reservoirs configured to store respective liquids, e.g., reservoir “A” 125, reservoir “B” 126, and reservoir “N” 127 that each is coupled to gas manifold 121. One or more of the liquids may include a reagent, e.g., a reagent suitable for use in polynucleotide amplification or sequencing. Any suitable number of reservoir(s) may be included in cartridge 120 and coupled to gas flow rate sensor 111 in any suitable manner. For example, cartridge 120 optionally may include a plurality of actuators (e.g., valves), each coupled to a respective reservoir, e.g., actuator “A” 122 coupled to reservoir “A” 125, actuator “B” 123 coupled to reservoir “B” 126, and actuator “N” 124 coupled to reservoir “N” 127. The actuator(s) may be electrically coupled to controller 115 via suitable electrical connector(s) such as any suitable combination of wire, electrical couplings, and wireless couplings. Actuators may be located between channel 128 and their respective reservoirs, e.g., so as substantially to isolate channel 128 from being affected by any pressure change in the reservoir. Controller 115 selectively may control the flow of pressurized gas to each of the reservoir(s) by actuating the actuator respectively coupled to that reservoir. Cartridge 120 may include channel 128 (e.g., a flow cell) configured to receive liquid that is displaced from the reservoir(s) by the respective flow of pressurized gas to such reservoirs (e.g., under the control of controller 115). Cartridge 120 optionally may include waste reservoir 129 configured to receive liquids from the channel 128.

Note that cartridge 120 may lack a sensor for measuring flow of the respective liquids, e.g., because controller 115 instead may be configured to calculate volumes of the respective liquid(s) that the flow of pressurized gas displaces from the respective reservoir(s). More specifically, controller 115 is configured to correlate the volume of gas that is passed through gas flow rate sensor 111 to the volume of liquid that is displaced from the respective reservoir by that gas. Without wishing to be bound by any theory, the following description provides a nonlimiting mathematical model of the process of liquid displacement by a gas the flow of which is measured by a gas flow rate sensor, under both steady-state and transient conditions.

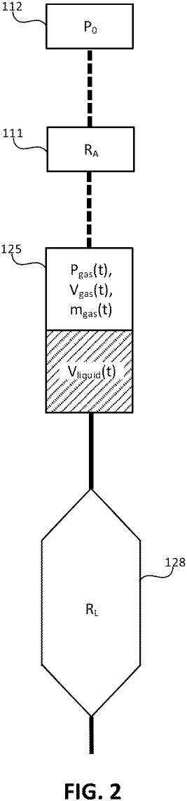

FIG. 2 schematically illustrates properties of selected components of the example system of FIG. 1. In the present model, atmospheric pressure is expressed as the constant Pₐₜₘ, the pressure of gas at regulator 112 is expressed as the constant P₀, and the collective gas resistance of gas flow rate sensor 111, regulator 112, and gas manifold 121 is expressed as the constant R_{A}, of which the gas resistance of the gas flow rate sensor may be expected to provide the majority of the resistance (e.g., greater than about 80%, greater than about 90%, or greater than 95% of the resistance). The gas pressure, gas volume, and gas mass inside of reservoir 125 respectively are expressed as the time-varying values P_{gas}(t), V_{gas}(t), and m_{gas}(t). The temperature T_{gas} of the gas inside of reservoir 125 is assumed to be constant and equal to that of the liquid within the reservoir. The liquid volume inside of reservoir 125 is expressed as the time-varying value V_{liquid}(t). The liquid resistance of cartridge 120, including the reservoirs, corresponding actuators, liquid channels, and channel 128 is expressed as the constant R_{L}, of which the liquid resistance of channel 128 may be expected to provide the majority of the resistance (e.g., greater than about 80%, greater than about 90%, or greater than 95% of the resistance).

When the actuator corresponding to the reservoir is open, the pressurized gas displaces the liquid from the reservoir as a function of time. The time-dependent change (increase) in volume of gas V_{gas}(t) inside the reservoir may be expressed as being related to the time-dependent change (decrease) in volume of liquid V_{liquid}(t) inside the reservoir according to equation (1):

$$\frac{d {V}_{g a s} \left(t\right)}{d t} = - \frac{d {V}_{l i q u i d} \left(t\right)}{d t} = \frac{{P}_{g a s} \left(t\right) - {P}_{a t m}}{{R}_{L}}$$

From equation (1), the total volume of gas within the reservoir may be expressed using equation (2):

$$\begin{matrix}{V}_{g a s} \left(t\right) = \text{-} {V}_{l i q u i d} \left(t\right) = {V}_{g a s} \left(t = 0\right) + {\int }_{0}^{t} \frac{d {V}_{g a s} \left(t\right)}{d t} d t = \\ {V}_{g a s} \left(t = 0\right) + {\int }_{0}^{t} \frac{{P}_{g a s} \left(t\right) - {P}_{a t m}}{{R}_{L}} d t\end{matrix}$$

At any given time t, the gas inside of reservoir 125 is expected to follow the ideal gas law even though the gas pressure, volume, and mass may be changing as a function of time:

$${P}_{g a s} \left(t\right) {V}_{g a s} \left(t\right) = {n}_{g a s} \left(t\right) R {T}_{g a s} = {m}_{g a s} \left(t\right) \times {C}_{1}$$

where

$${C}_{1} = \frac{R {T}_{g a s}}{{M}_{g a s}} ,$$

R is the ideal gas constant, and M_{gas} is the molar mass of the gas.

Taking the derivative of equation (3) with respect to time, equation (4) below is obtained which expresses the time-varying mass of the gas within the reservoir as a function of the time-varying volume and time-varying pressure of the gas within the reservoir:

$${C}_{1} \left(t\right) \frac{d {m}_{g a s} \left(t\right)}{d t} = {V}_{g a s} \left(t\right) \frac{d {P}_{g a s} \left(t\right)}{d t} + {P}_{g a s} \left(t\right) \frac{d {V}_{g a s} \left(t\right)}{d t}$$

The time-varying mass of the gas within the reservoir also may be expressed using equation (5) below:

$$\begin{matrix}\frac{d {m}_{g a s} \left(t\right)}{d t} = {Q}_{g a s} \left(t\right) \times {ρ}_{g a s} = {Q}_{g a s} \left(t\right) \frac{{T}_{s} {P}_{g a s} \left(t\right)}{{T}_{g a s} {P}_{s}} {ρ}_{s} = \\ {P}_{g a s} \left(t\right) \times {Q}_{g a s} \left(t\right) \times {C}_{2}\end{matrix}$$

in which ρₛ is the gas density at the standard condition (standard temperature Tₛ of 0° C. and standard pressure Pₛ of 101.325 kPa); Q_{gas} is the actual volumetric flow rate of the gas as a function of time; ρ_{gas} is the actual gas density; and C₂ is the correction factor

$$\frac{{T}_{s}}{{T}_{g a s} {P}_{s}} {ρ}_{s}$$

that addresses the temperature and pressure difference from the standard condition.

According to Poiseuille’s law, the time-dependent gas volumetric flow rate Q_{gas} may be correlated to the time-dependent pressure difference across the gas flow rate sensor as well as the gas flow rate sensor’s resistance R_{A} against the gas, as may be expressed by equation (6):

$${Q}_{g a s} \left(t\right) = \frac{{P}_{0} - {P}_{g a s} \left(t\right)}{{R}_{A}}$$

Equations (5) and (6) may be combined to obtain equation (7) below:

$$\frac{d {m}_{g a s} \left(t\right)}{d t} = {P}_{g a s} \left(t\right) \frac{{P}_{0} {P}_{g a s} \left(t\right)}{{R}_{A}} {C}_{2}$$

Equations (1), (2), (3), and (7) then may be combined to obtain equation (8) below which describes the time-dependent change in pressure of the gas inside of the reservoir, while the actuator corresponding to that reservoir is open:

$$\frac{d {P}_{g a s} \left(t\right)}{d t} = \frac{\left[\frac{{P}_{g a s} \left(t\right)}{{R}_{A}} \times \left({P}_{0} - {P}_{g a s} \left(t\right)\right) - \left(\frac{{P}_{g a s} \left(t\right) - {P}_{a t m}}{{R}_{L}}\right) \times {P}_{g a s} \left(t\right)\right]}{\left[{V}_{g a s} \left(t = 0\right) + {\int }_{0}^{t} \frac{{P}_{g a s} \left(t\right) - {P}_{a t m}}{{R}_{L}} d t\right]}$$

From equations (8), (1), and (2), it may be understood that the time integration of the liquid flow rate is substantially equal to the time integration of the gas flow rate, and that either of these values provides the volume of the liquid dispensed by the gas flow. Accordingly, from the output gas flow rate measured by the gas flow rate sensor, controller 115 readily may calculate V_{gas}(t₂-t₁) and V_{liquid}(t₂-t₁) using equation (2). Accordingly, the volume of the liquid displaced from the reservoir may be calculated based on the flow rate of the gas measured by the gas flow rate sensor.

The time-dependent change in pressure of the gas inside the reservoir, when the actuator corresponding to that reservoir is closed, may be obtained similarly. When the actuator is closed, there is no liquid coming out the reservoir, therefore the gas volume inside the reservoir is substantially constant and may be expressed as V_{A}. From equations (3) and (7), equation (9) may be obtained:

$$\frac{d {P}_{g a s} \left(t\right)}{d t} = {P}_{g a s} \left(t\right) \frac{{P}_{0} - {P}_{g a s} \left(t\right)}{{V}_{A} {R}_{A}}$$

where V_{A} is a constant in equation (9) corresponding to the gas headspace in the reservoir when the actuator is closed. The analytical solution of equation (9) provides the time-dependent pressure of the gas in the reservoir when the corresponding actuator is closed.

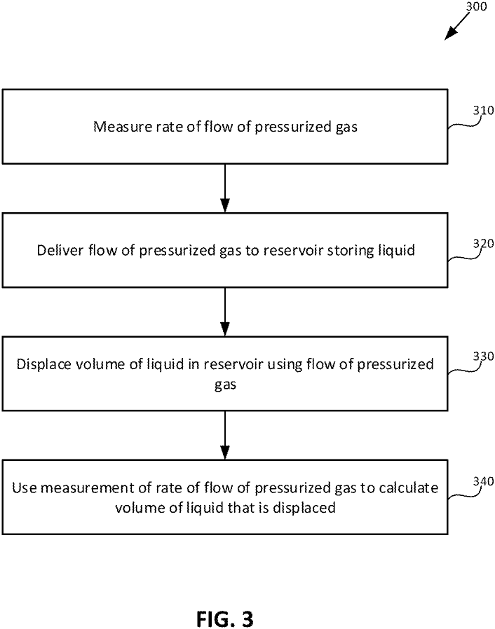

It will further be appreciated that the volume of a liquid may be measured using any suitable combination of hardware and software, and is not limited to the particular implementation described with reference to FIGS. 1 and 2. For example, FIG. 3 illustrates an example flow of operations in a method 300 for measuring liquid flow through a channel. Method 300 may include measuring a rate of flow of a pressurized gas (operation 310). Such a flow rate may be measured using any suitable sensor, for example a gas flow rate sensor such as described with reference to FIG. 1. Method 300 may include delivering the flow of the pressurized gas to a reservoir storing a liquid (operation 320). For example, a gas channel may couple the sensor to the reservoir in a manner such as described with reference to FIG. 1. Method 300 may include displacing a volume of the liquid in the reservoir using the flow of pressurized gas (operation 330). For example, in a manner such as described with reference to FIGS. 1 and 2, the gas may displace the liquid, causing the liquid to be dispensed from the reservoir into a channel. Method 300 may include using the measurement of the rate of flow of the pressurized gas to calculate the volume of the liquid that is displaced (operation 340). For example, controller 115 may implement operations such as described with reference to FIG. 2 to calculate the volume of liquid displaced by the gas, based on the rate of flow of the pressurized gas. Illustratively, controller 115 may be configured to calculate V_{liquid}(t) by integrating the volumetric flow rate, which may be output by gas flow rate sensor 111, and any suitable equation(s) such as equations 8 and 2 in a manner such as described with reference to FIG. 2. While such operations suitably may be performed for a single liquid, it will be appreciated that they also may be performed for multiple liquids. For example, the flow of pressurized gas may displace a plurality of fluids from a plurality of reservoirs storing respective liquids, and method 300 may include calculating volumes of the respective liquids that the flow of pressurized gas displaces from the respective reservoirs.

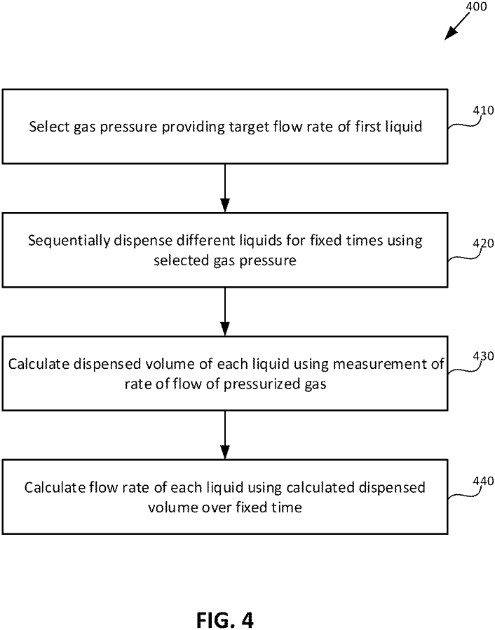

The dispensed volumes of liquids may be calculated using the gas flow rate at any suitable time. In some examples, the volumes are calculated during calibration of the instrument or cartridge. For example, as will be apparent from the equations and discussion of FIG. 2 above, different channels in the cartridge may have different resistances which may affect the gas flow rate and the volume of liquid that the gas flow displaces. In some examples, such resistances are relatively constant during use of the instrument or cartridge, as is the flow rate of the gas into the reservoir. As such, the flow rate of the liquid out of the reservoir may be determined during a pre-run calibration. FIG. 4 illustrates an example flow of operations in a method 400 for calibrating a measurement of liquid flow through a channel. Method 400 includes selecting a gas pressure providing a target flow rate of a first liquid (operation 410). For example, at each of a variety of different gas pressures, controller 115 may open the actuator for a first reservoir so that the pressurized gas may displace the fluid within that reservoir; may calculate the flow rate of that liquid at each of the gas pressures based on measurements of the gas flow rate; and may select the gas pressure that provides the target flow rate of that liquid. Controller 115 then may communicate that gas pressure to an operator who sets the pressure accordingly using the regulator, or controller 115 may electronically set the pressure using the regulator. Method 400 includes sequentially dispensing different liquids for fixed times using the selected gas pressure (operation 420). For example, controller 115 may open the actuator for one of the reservoirs while keeping the remaining actuators closed so that the pressurized gas selectively displaces liquid from that reservoir, and then sequentially may repeat such operations for the other actuators and the corresponding reservoirs and liquids. In some examples, the method includes using gas pressure to sequentially dispense liquids from at least two reservoirs. In some examples, liquids are dispensed from each of the at least two reservoirs for a fixed time period. In some examples, the fixed time period that each reservoir dispenses liquid is variable relative to other reservoirs. In some examples, each of the at least two reservoirs contains a different liquid.

Method 400 includes calculating the dispensed volume of each liquid using the measurement of the rate of flow of the pressurized gas (operation 430), e.g., in a manner such as described with reference to FIG. 3. Method 400 includes calculating the flow rate of each liquid using the calculated dispensed volume over the corresponding fixed time (operation 440). For example, controller 115 may divide the calculated dispensed volume of each liquid by the fixed time for which the actuator is open for that liquid, to obtain the flow rate of that liquid at the selected gas pressure. As such, the calibration procedure of FIG. 4 allows controller 115 to calculate the volume of each liquid that is dispensed per unit time that the corresponding actuator is open. Therefore, controller 115 readily may control the actuators to be open for a suitable amount of time to dispense appropriate amounts of the corresponding liquids for the particular context in which those fluids are to be used, using the calibrated liquid flow rates.

In other examples, the calculated volume of at least one of the dispensed liquids may be used to implement closed-loop control. For example, a non-essential liquid dispensing operation (such as a wash operation) may be broken into multiple sub-operations for which the dispensed volume may be calculated in a manner such as described with reference to FIG. 3. The average of the calculated volume dispensed in the sub- operations may be used to determine if there is any bias, e.g., an overdelivery or an underdelivery of the liquid. If the bias exceeds a threshold, controller 115 may correct the bias by decreasing or increasing the actuator open time for the non-essential liquid as well as for the other liquids so that the appropriate amount of each such liquid is dispensed. Alternatively, if the bias does not exceed the threshold, then controller 115 need not change the actuator open time. It will be appreciated, however, that the controller 115 may calculate the volume of any liquid delivered during a given fluidic cycle. Additionally, based on such calculation, controller 115 optionally may adjust the timing of the actuator opening and closing, and/or may adjust the gas pressure, for a subsequent cycle so as to dispense the volume of the liquid more accurately during that subsequent cycle. Such adjustments may be made on a per-cycle basis, or may be made less frequently.

From the foregoing, it will be appreciated that the present instruments, systems, and methods provide real-time monitoring of the volume of a liquid being used, including any change of liquid resistance of the cartridge. Such feature may be used to implement “closed-loop” flow rate regulation to achieve enhanced stability and reliability with which liquids are dispensed. Additionally, or alternatively, the present instruments, systems, and methods may be used to provide a “dry instrument” in which substantially no liquids enter the instrument, thus promoting robustness of the instrument. Additionally, or alternatively, the present instruments, systems, and methods provide for liquid metering using a gas flow rate sensor inside the instrument, and as such no metering component need be provided in the cartridge, such as a syringe pump. As such, the complexity, cost, and footprint of the instrument and cartridge may be reduced. Additionally, or alternatively, the present instruments, systems, and methods may measure liquid volumes with relatively high accuracy. For example, as explained below in the Working Examples, the average volumetric error rate (%) of 1200 cycles was measured to be around 3%. Additionally, or alternatively, because the present instruments, systems, and methods are based on the measurement of volume of dispensed gas (from which the volume of dispensed may be calculated), the accuracy of the measurement substantially may not be affected by any change of viscosity, density, or other fluidic property of the liquid(s). Optionally, a temperature sensor may be used to measure the temperature of the reservoir, and such measurement used to adjust the volume calculation in view of variations in temperature. Additionally, or alternatively, the gas flow rate sensor inside the instrument may be used not only for metering, but also used for pre-run/in-run leak test/blockage test of the cartridge without the need for an extra sensor to perform such test(s). Additionally, because a gas (such as air, nitrogen, or a noble gas) may be the only medium that contacts the gas flow rate sensor, there is reduced risk of contamination or corrosion as compared to use of a liquid flow sensor which may contact, and be degraded and/or contaminated by, liquids.

It should be appreciated that controller 115 may be implemented using any suitable combination of digital electronic circuitry, integrated circuitry, application specific integrated circuits (ASICs), field programmable gate arrays (FPGAs), central processing units (CPUs), graphical processing units (GPUs), computer hardware, firmware, software, and/or combinations thereof. For example, one or more functionalities of controller 115 may be implemented in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as modules, programs, software, software applications, applications, components, or code, can include machine instructions for a programmable processor, and/or can be implemented in a high-level procedural language, an object-oriented programming language, a functional programming language, a logical programming language, and/or in assembly/machine language. As used herein, the terms “memory” and “computer-readable medium” refer to any computer program product, apparatus and/or device, such as magnetic discs, optical disks, solid-state storage devices, memory, and Programmable Logic Devices (PLDs), used to provide machine instructions and/or data to a programmable data processor, including a machine-readable medium that receives machine instructions as a computer-readable signal. The term “computer-readable signal” refers to any signal used to provide machine instructions and/or data to a programmable data processor. The computer-readable medium can store such machine instructions non-transitorily, such as would a non-transient solid-state memory or a magnetic hard drive or any equivalent storage medium. The computer-readable medium can alternatively or additionally store such machine instructions in a transient manner, such as for example as would a processor cache or other random-access memory associated with one or more physical processor cores.

The computer components, software modules, functions, data stores and data structures can be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality can be located on a single computer or distributed across multiple computers and/or the cloud, depending upon the situation at hand.

In one nonlimiting example, controller 115 described with reference to FIGS. 1-2 may be implemented using a computing device architecture. In such architecture, a bus (not specifically illustrated) can serve as the information highway interconnecting the other illustrated components of the hardware. The system bus can also include at least one communication port (such as a network interface) to allow for communication with external devices either physically connected to the computing system or available externally through a wired or wireless network. Controller 115 may be implemented using a CPU (central processing unit) (e.g., one or more computer processors/data processors at a given computer or at multiple computers) that can perform calculations and logic operations required to execute a program. Controller 115 may include a non-transitory processor-readable storage medium, such as read only memory (ROM) and/or random-access memory (RAM) in communication with the processor(s) and can include one or more programming instructions for the operations provided herein, e.g., for implementing methods 300 and/or 400. Optionally, the memory may include a magnetic disk, optical disk, recordable memory device, flash memory, or other physical storage medium. To provide for interaction with a user, controller 115 may include or may be implemented on a computing device having a display device (e.g., a CRT (cathode ray tube) or LCD (liquid crystal display) monitor) for displaying information obtained to the user and an input device such as keyboard and/or a pointing device (e.g., a mouse or a trackball) and/or a touchscreen by which the user can provide input to the computer.

### Methods of Using Cartridges Including Channels

As noted elsewhere herein, oligonucleotides may be coupled to a region of a substrate within a flow cell, e.g., a flow cell such as described with reference to FIG. 1. Oligonucleotides coupled to substrates may be used in a variety of amplification techniques. Example techniques that can be used include, but are not limited to, polymerase chain reaction (PCR), rolling circle amplification (RCA), multiple displacement amplification (MDA), or random prime amplification (RPA), or a combination thereof. In some examples, one or more primers used for amplification may be coupled to the substrate. Formats that utilize two or more species of attached primer enable bridge amplification (BridgeAmp) or kinetic exclusion amplification (ExAmp), in which amplicons may form bridge-like structures between two attached primers that flank the template sequence that has been copied. Amplification can also be carried out with one amplification primer attached to a substrate and a second primer in solution (e.g., emulsion PCR).

Additionally, or alternatively, oligonucleotides coupled to substrates in a manner such as described herein may be used for determining the sequence of a target polynucleotide. For example, a target polynucleotide may be coupled (e.g., hybridized) to one of a plurality of primers covalently bound to a substrate in a manner such as described herein. The target polynucleotide may be amplified using the plurality of primers to form a cluster of substrate-bound amplicons. The cluster of substrate-bound amplicons may be contacted with labeled nucleotides (e.g., fluorescently labeled nucleotides) and a polymerase such that a detectable signal (e.g., fluorescence) is generated while a nucleotide is incorporated by the polymerase, and such signal may be used to identify the nucleotide and thereby determine a nucleotide sequence of the target polynucleotide.

It will be appreciated that a system for sequencing polynucleotides may include the instrument and the cartridge described with reference to FIGS. 1 and 2, and may implement operations such as described with reference to FIGS. 3-4. For example, the liquids in the reservoirs of the cartridge may include reagents suitable for use in sequencing polynucleotides, and controller 115 may control the corresponding actuators so as to appropriately dispense the reagents for use in amplifying and sequencing target polynucleotides.

### WORKING EXAMPLES

Equations (8) and (9) were used to derive the numerical solutions for the air (gas) volumetric flow rate and reagent (liquid) flow rate using computer modeling either during valve (actuator) open or valve (actuator) closed. In this modeling, the valve open time was simulated to be 25 s, followed by valve closing with a duration of 160 s. Pressure output from pressure source was modeled to be 4 psi. The liquid resistance of the cartridge was modeled to be 1.33 psi*min/ml and the air resistance of the air flow meter is 0.05 psi*min/ml. The simulation time step was 1 ms.

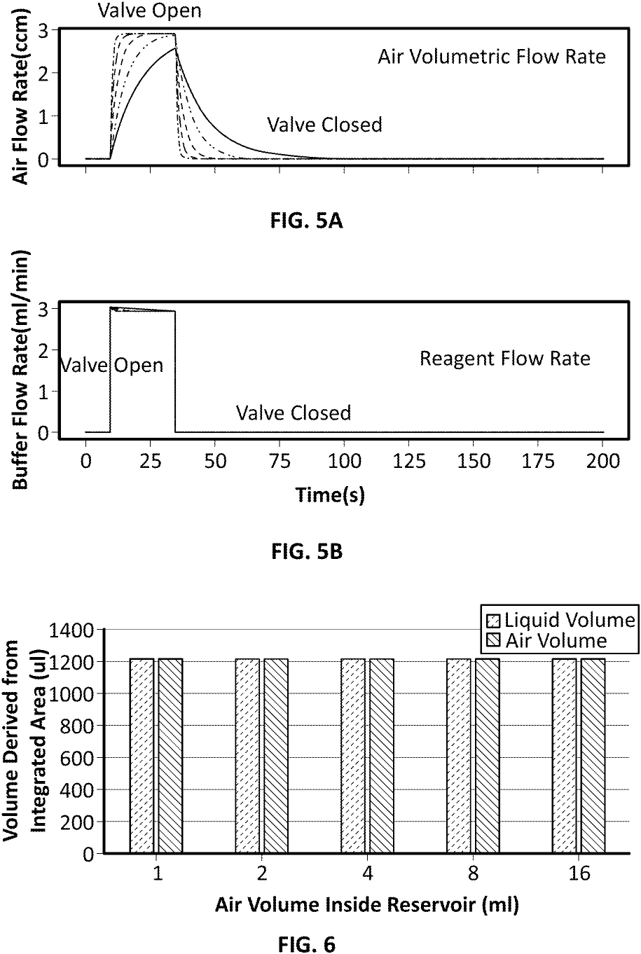

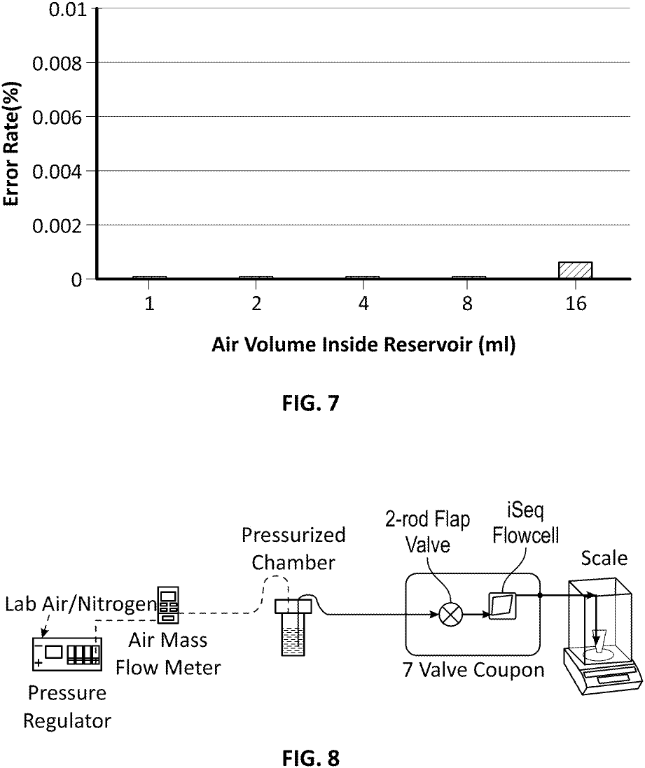

FIGS. 5A-5B are plots respectively illustrating the simulated air volumetric flow rate and corresponding reagent flow rate for different starting parameters. The simulation traces of different colors in FIGS. 5A-5B represent simulations with different initial air volumes inside the reservoir. As may be understood from FIGS. 5A-5B, the initial air volume affects the time to reach steady state for air volumetric flow rate but substantially does not affect the reagent flow rate. Integrating the area under the curves of different colors for both air volumetric flow rate and reagent flow rate provides volume dispensed for both air and liquid during the valve opening. FIG. 6 is a plot illustrating a comparison of the simulated air volumetric flow rate and corresponding reagent flow rate for different starting parameters. From FIG. 6, it may be understood that, during the period of valve opening, the dispensed volume of liquid (i.e. reagent) and the volume of air that passes through and measured by the air mass flow sensor substantially are volumetrically equivalent regardless of the initial reservoir air volumes and shapes of the curves. The percentage error rate, which measures the percentage difference between the air volume and liquid volume using liquid volume as a reference, also was calculated. FIG. 7 is a plot illustrating the mismatch between the simulated air volumetric flow rate and corresponding reagent flow rate for different starting parameters. FIG. 7 confirms that the percentage differences between liquid volume and air volume are less than 0.002%, across different initial air volumes (from 1ml to 16ml). Negligible mismatch between the simulated air volumetric flow rate and corresponding reagent flow rate was also found for several different sets of starting parameters.

To further illustrate the robustness of the present methods, FIG. 8 schematically illustrates a setup used to calculate volumes of liquid displaced by a pressurized gas. In the diagram, the pressure regulator is connected to the pressurized chamber via the air mass flow metering, which is utilized to monitor the air flow rate during the metering test. The pressurized chamber is connected to the downstream flow cell/fluidic channel with on-coupon valves for the fluidic controlling. During the experiments, an aqueous buffer liquid inside the chamber was pressurized, pumped out and flow through the fluidic channel, valve and the flow cell, eventually entering into a tube on the scale for the gravimetric measurement. The volume derived from the measured mass is considered as the “true” volume (or reference) dispensed by this setup. The volume calculated based on measurements from the air flow meter is compared to this reference value for the calculation of the accuracy represented as error rate (%). The regulated pressure output was 4.5 psi. At that pressure, around 20-30 ul of test buffer was delivered to the scale for each cycle during a valve open time of 0.5 s. The flow rate was approximately 2400 ul/min. Several hundred cycles of dispensing liquid were performed, with time interval of 5 seconds between neighboring cycles. The percentage error was calculated using the formula:

$$P e r c e n t a g e e r r o r \left(\%\right) = \frac{a i r v o l u m e - l i q u i d v o l u m e}{l i q u i d v o l u m e} \times 100$$

The mean absolute percentage error was calculated using the formula:

$$M e a n a b s o l u t e p e r c e n t a g e e r r o r \left(\%\right) = {\sum }_{i = 1}^{n} \left|\frac{E r r o {r}_{i} \left(\%\right)}{n}\right| .$$

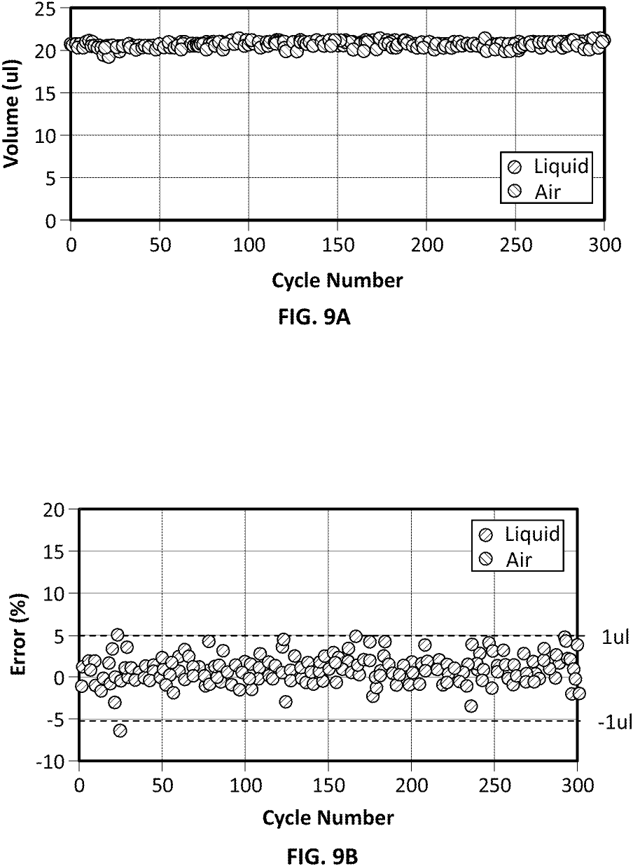

FIG. 9A illustrates the volumes of liquid and pressurized gas measured using the setup of FIG. 8. From FIG. 9A, it may be understood that the measured volume of liquid was approximately equal to the measured volume of air for at least 300 cycles. FIG. 9B illustrates the percentage error of the volumes of liquid calculated using the setup of FIG. 8. From FIG. 9B, it may be understood that the error rate was substantially less than 5%. The mean absolute percentage error (MAPE) was calculated to be approximately 1.37%.

### Additional Comments

It is to be understood that any respective features/examples of each of the aspects of the disclosure as described herein may be implemented together in any appropriate combination, and that any features/examples from any one or more of these aspects may be implemented together with any of the features of the other aspect(s) as described herein in any appropriate combination to achieve the benefits as described herein.

While various illustrative examples are described above, it will be apparent to one skilled in the art that various changes and modifications may be made therein without departing from the invention. The appended claims are intended to cover all such changes and modifications that fall within the true spirit and scope of the invention.

1. An instrument comprising:
a gas flow rate sensor to measure a rate of flow of a pressurized gas to a reservoir storing a liquid; and
a controller coupled to the gas flow rate sensor to calculate a volume of the liquid that the flow of pressurized gas displaces from the reservoir.

2. The instrument of claim 1, wherein the flow of pressurized gas displaces a plurality of fluids from a plurality of reservoirs storing respective liquids, and wherein the controller calculates volumes of the respective liquids that the flow of pressurized gas displaces from the respective reservoirs.

3. The instrument of claim 2, wherein the respective liquids comprise reagents.

4. The instrument of claim 2, wherein the reservoirs are located within a cartridge that is removably coupled to the instrument.

5. The instrument of claim 2 , wherein the controller actuates a plurality of actuators to selectively control the displacement of the liquids.

6. The instrument of claim 5, wherein the actuators comprise valves.

7. The instrument of claim 5 , wherein the actuators are located on the cartridge.

8. The instrument of claim 1 , wherein the liquid is displaced into a channel.

9. The instrument of claim 8, wherein the channel comprises a flow cell.

10. The instrument of claim 1 , wherein the gas comprises nitrogen.

11. The instrument of claim 1 , further comprising a pressure regulator coupled upstream of the gas flow rate sensor.

12. A system comprising the instrument and the cartridge of claim 4 .

13. A cartridge, comprising:
a gas manifold to receive a flow of a pressurized gas;
a plurality of reservoirs storing respective liquids;
a channel to receive liquids dispensed from the plurality of reservoirs responsive to flow of the pressurized gas from the gas manifold into respective reservoirs;
a plurality of actuators, each coupled to the channel and to a respective reservoir; and
an electrical connector to electrically couple the actuators to a controller.

14. The cartridge of claim 13, further comprising a waste reservoir to receive liquids from the channel.

15. The cartridge of claim 13 , further comprising the respective liquids.

16. The cartridge of claim 15, wherein the respective liquids comprise reagents.

17. (canceled)

18. The cartridge of claim 13 , wherein the actuators comprise valves.

19. The cartridge of claim 13 , wherein the channel comprises a flow cell.

20. The cartridge of claim 13 , wherein the cartridge lacks a sensor for measuring flow of the respective liquids.

21. The cartridge of claim 13 , wherein the cartridge lacks a syringe pump for pulling the respective liquids.

22. (canceled)

23. A method comprising:
measuring a rate of flow of a pressurized gas;
delivering the flow of the pressurized gas to at least one reservoir storing at least one liquid so as to displace a volume of the at least one liquid in the at least one reservoir using the flow of pressurized gas; and
using the measurement of the rate of flow of the pressurized gas to calculate the volume of the liquid that is displaced.

24-45. (canceled)
